(19) United States
(12) Patent Application Publication
(10) Pub. No.: US 2015/0019236 A1
(43) Pub. Date: Jan. 15, 2015

(54) DATA AGE DISPLAY AND MANAGEMENT

(71) Applicant: Covidien LP, Mansfield, MA (US)

(72) Inventors: Robert T. Boyer, Longmont, CO (US); David Fox, Longmont, CO (US)

(21) Appl. No.: 13/941,959

(22) Filed: Jul. 15, 2013

(51) Int. Cl. G06F 19/00

(52) U.S. Cl. CPC G06F 19/345
USPC 705/2

(57) ABSTRACT

A system and method for displaying patient data, the system includes a computing device having a processor and a data input for receiving measured values and measurement times of a plurality of factors related to the screening of a particular disease, and a display configured to display a user interface. The user interface includes the plurality of factors, the measured values for each of the plurality of factors, data ages of the measured values, and a score, calculated by the processor, of the measured value as a function of the particular disease based on the measured values and a data age for each of the plurality of factors. The user interface also displays a screening result of whether the patient has passed the screening of the disease.

### TECHNICAL FIELD

The present disclosure relates generally to systems and methods for the management and display of personal data.

### BACKGROUND

Generally, early detection of a disease is one of the keys to successful treatment of the patient resulting in efficient and effective treatment with favorable outcomes. In order to diagnose a patient, medical professionals gather necessary information including test results, vital signs information, personal history, etc. The medical professional, reviewing all information, typically in the form of paper test results and/or electronic medical records (EMR) is then able to proceed with a diagnosis. Even though a medical professional has all medical information necessary to diagnose a patient with a disease, diagnosis may nonetheless be inaccurate or even invalid due to different measurement times and different shelf-lives of each type of medical information or testing results.

### SUMMARY

The present disclosure relates to systems and methods for managing and displaying personal data. The systems in accordance with the present disclosure include a computing device including a processor and a data input, and a display. The data input receives measured values and measurement times of factors related to the diagnosis of a particular disease. The display displays a user interface that includes the factors, the measured values for each of the factors, data ages, scores, and a diagnosis result. Each score of a measured value is calculated by the processor as a function of the disease and is based on the measured values and a determined data age for each of the factors. Methods for managing and displaying personal data are also provided.

The aspects and features of the present disclosure are advantageous in that, by displaying medical data in close proximity with corresponding data ages, medical professionals may easily recognize validity of the medical data because the data ages indicate the time since the collection of the medical data and allows for comparison to the corresponding shelf-lives of that specific type of medical data. The aspects and features of the present disclosure are also advantageous in that, by displaying a score for each of medical data, medical professionals may be alerted to factors which weight more heavily in making a determination or having large scores. Further the medical professional may be alerted to a medical data value that is color-coded, shaded, highlighted, boxed, and/or otherwise decorated. The aspects and features of the present disclosure are further advantageous in that, by displaying a screening result that a patient is identified as having passed a screening for a potential disease, the medical professional may readily determine the status of the patient and treat the patient accordingly.

Certain embodiments of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

### BRIEF DESCRIPTION OF THE DRAWINGS

The present disclosure and its various aspects and features are described below with reference to the accompanying drawings:

FIG. 1 is a schematic illustration of a system that monitors and displays personal data in accordance with embodiments of the present disclosure;

FIG. 2 is a block diagram illustrating a hardware configuration for remote devices of the system of FIG. 1;

FIG. 3 illustrates personal data displayed on a display screen provided in accordance with the present disclosure;

FIG. 4 illustrates personal data displayed on a mobile device in accordance with the present disclosure; and

FIG. 5 is a flow diagram illustrating a method of managing and displaying personal data in accordance with the present disclosure.

### DETAILED DESCRIPTION

Systems and methods for managing and displaying personal data for screening for early identification of a disease are provided in accordance with the present disclosure. Screening for early identification of a disease may require gathering medical information of a patient and analyzing the medical information. For some diseases, medical professionals consider only a few types of medical data in order to reach a diagnosis. For example, systemic inflammatory response syndrome (SIRS) may be diagnosed based on patient's heart rate, body temperature, respiratory rate, and white blood cell count. These medical data types are typically measured at different time intervals. Thus, managing data ages of the medical data values that are measured at different times is critical to determine validity of the medical data for purposes of conducting a screening for early identification of a disease. Further, the screening determination that a patient has passed a screening for early identification of a disease is based on a set of rules which considers each of these types of medical data both individually and in combination. According to one embodiment of the present disclosure, a score for each of the types of medical data as well as a total score aggregating the individual scores is displayed on a user interface. By viewing the user interface, medical professionals may readily and easily see whether the combination of medical data should be considered as indicating a diagnosis that the patient has SIRS. As such, the systems and methods of the present disclosure provide valuable information to medical professionals by managing and displaying the data ages of medical data. One of skill in the art will readily recognize that while SIRS is used as an example, any disease that has a variety of medical data types may utilize the methods and system described herein.

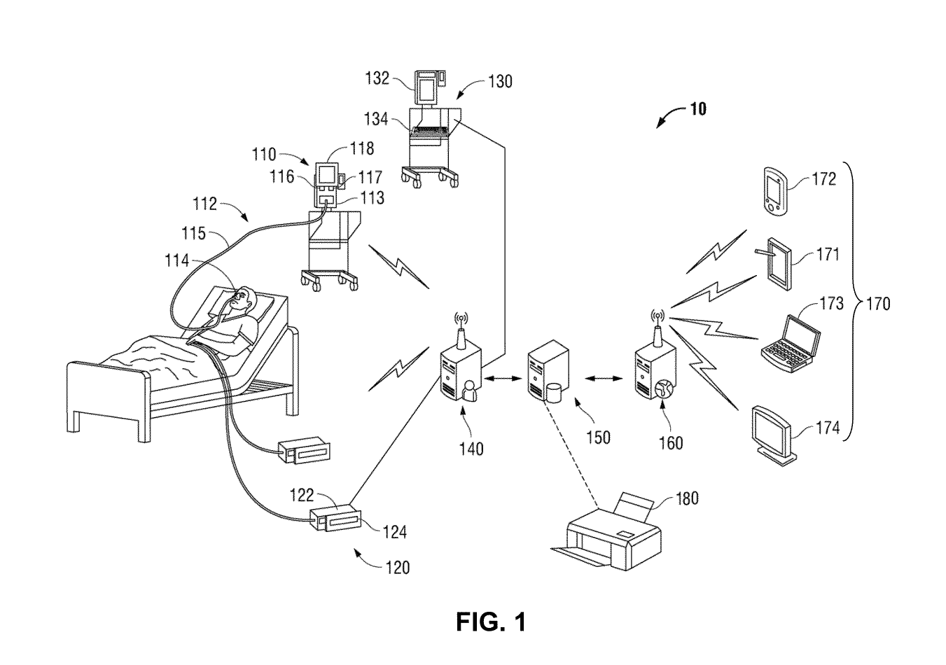

FIG. 1 illustrates a system 10 that monitors and displays personal data in accordance with the present disclosure. System 10 includes one or more patient care devices 110, one or more patient monitoring devices 120, one or more bedside devices 130, one or more data servers 140, one or more application servers 150, one or more web servers 160, one or more remote devices 170, and a printer 180. The system 10 may be implemented, incorporated, or utilized with any other devices, systems, and combinations.

The one or more patient care devices 110 may include, for example, a ventilator system 112 that may be any suitable ventilator system, e.g., the Puritan Bennett™ 840 Ventilator System sold by Covidien LP of Boulder, Colo., USA, and generally includes a bedside unit 113, a patient interface member 114, e.g., an insertion tube (for invasive ventilation) or mask (for noninvasive ventilation), and a pair of tubes 115, e.g., an inflow tube and an outflow tube, interconnecting the bedside unit 113 and patient interface member 114. Bedside unit 113 controls the supply of oxygenated air to the patient and includes at least a first input 116 for allowing a clinician to set a desired Fraction of inspired Oxygen (FiO₂) level and a second input 117 for allowing a user to set a desired Positive-End Expiratory Pressure (PEEP). Bedside unit 113 may further include a display 118 for displaying relevant data relating to ventilation system 112 and/or the patient. The bedside unit 113 may measure the patient's respiratory rate, the rate of inhaling and exhaling per a unit time. The bedside unit 113 may be coupled to one or more servers 140, 150, 160, e.g., data server 140, either wirelessly or via a wired connection. The bedside unit 113 may transfer measured values, e.g., the respiratory rate, with measurement times to the data server 140 automatically or when requested from the data server 140. The bedside unit 113 may include any suitable software, firmware, and hardware for the above purposes.

The one or more patient monitoring devices 120 may include, for example, a sensor 122. The sensor 122 may be a temperature sensor that measures a patient's body temperature or other sensors, such as a heart rate sensor that counts heartbeats per unit time, a visual monitor and/or audible monitor monitoring the physical characteristics, physiological conditions, and/or other measurable medical status of the patient. A temperature sensor or a heart rate sensor may be configured to display temperature or heart rate data on a visual display 124 and/or may be configured to relay temperature or heart rate data to one or more servers 140, 150, 160. The sensor 122 may be wirelessly coupled to data server 140, or may be coupled to data server 140 via a wired connection. The sensor may transfer the measured values, e.g., body temperature and heart rate, with measurement times to the data server 140 automatically or when requested. The sensor 122 may include any suitable software, firmware, and hardware for the above purposes.

The bedside device 130 may include a display 132 and a user input 134, e.g., a touch-screen display or keyboard and mouse. The bedside device 130 is employed to display relevant parameters, conditions, sensed data, and/or other patient information on display 132 at a patient's bedside. Bedside device 130 is further configured to receive user input data via user input 134 for display on display 132 and/or for transmission to data server 140 (and/or the other servers 150, 160). Information transferred into the bedside device 130 may include medical care information, e.g., the patient's drug administration schedule, other measured data, e.g., the patient's white blood cell (WBC) count, and/or biographical or other observed data/notes. Furthermore, the information transferred into the bedside device may include measurement time data of the patient's temperature, heart rate, and/or other measured medical conditions. The bedside device 130 may be connected with the data server 140 wirelessly or via a wired connection. The bedside device 130 may include any suitable software, firmware, and hardware for the above purposes. Alternatively or additionally to the bedside devices 130, patient monitoring devices 120, and patient care devices 110, information relating to the patient may be automatically pulled from another system, e.g., a patient's Electronic Medical Record (EMR), an Admission, Discharge, and Transfer (ADT) electronic file, lab data, etc.

The data server 140, the application server 150, and the web server 160 are connected to each other and also connected to both remote devices 170 and the local devices, e.g., the ventilator system 112, the sensor 122, and the bedside device 130, for storing, processing, and/or transmitting information among them. More specifically, one or more of servers 140, 150, 160 are configured to store information, e.g., the parameters, conditions, sensed data, reports, other information, and/or measurement times thereof, in a database and to process the information. The servers 140, 150, 160 are further configured to cooperate with one another to transmit information between the servers 140, 150, 160, other systems, e.g., a patient's EMR, an ADT electronic file, lab data, etc., the ventilator system 112, the sensor 122, the bedside device 130, the remote devices 170, and/or printer 180. The servers 140, 150, 160 may include any suitable software, firmware, and hardware for these purposes and may establish the above-described communication via wired and/or wireless communication.

The remote devices 170 request and receive information, e.g., the parameters, conditions, sensed data, other information, and/or measurement times thereof, process the information if needed, and display the processed information to a user, e.g., via a display monitor, user interface, browser, and/or application running on the remote devices 170, or otherwise output the information to a user, e.g., print a generated report containing the information via the printer 180. A user may input information to the remote devices 170, control display or output of the information, set parameters, reset notifications, etc. Information input into the remote devices 170 may include medical care information, e.g., the patient's drug administration schedule, other measured data, e.g., the patient's white blood cell (WBC) count, body temperature, heartbeats, and/or biographical or observed data. The remote devices 170 may include one or more tablet personal computers (PCs) 171, a mobile device 172, laptop computers 173, a terminal 174, or other suitable devices and may incorporate any suitable software, firmware, and hardware for the above purposes. The remote device 170 may have in memory a software program performing the above identified functions, an application or app running locally on the remote device, or simply act as a display (e.g., thin-client architecture) for displaying and interacting with the requested information presented to the remote device from the web server 160.

In embodiments, the remote devices 170 may have a security feature through which a user can modify or enter personal data. By using security information of a medical professional, only authenticated personnel may modify, update, input, and/or save personal data. Security information may include identification and corresponding password, or bio information, e.g., fingerprint and/or eye's iris.

The printer 180 may print personal data including the parameters, conditions, sensed data, reports, other information, and/or measurement times thereof. The printer 180 is connected in the system 10 via wired connection or wirelessly. Other devices in the system 10, e.g., the remote devices 170, servers 140-160, the bedside device 130, the ventilating device 120, and/or sensor 120 may send data to the printer 180 to print the data.

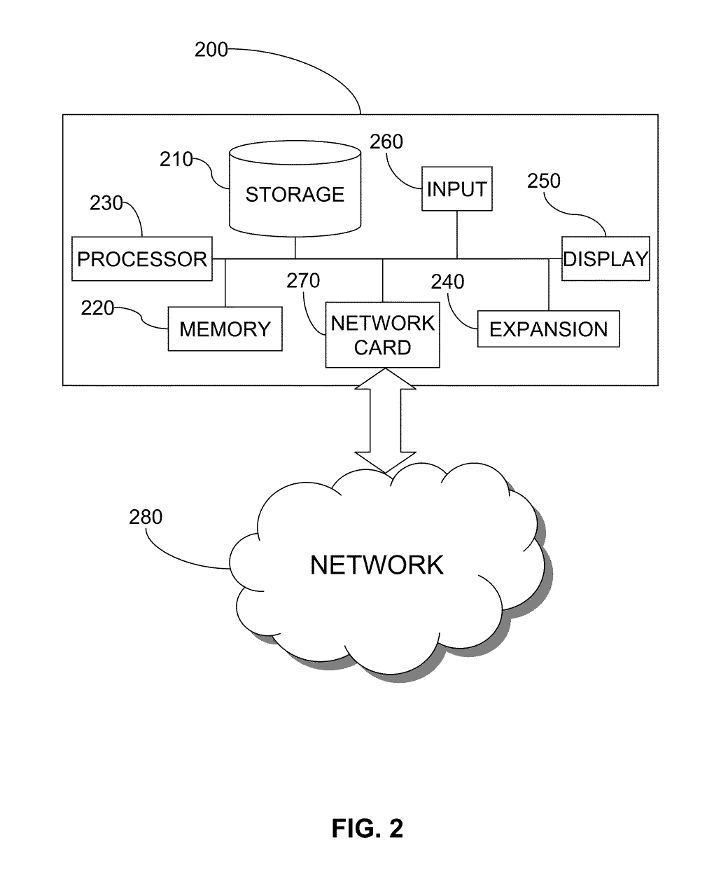

FIG. 2 illustrates a block diagram illustrating a hardware configuration for remote devices 170 of the system 10 of FIG. 1. The hardware configuration 200 may include a storage 210, memory 220, processor 230, expansion 240, display 250, input unit 260, and network card 270. The storage 210 stores data to be accessed for reading and editing and programs to be executed. The memory 220 may include a random access memory (RAM) and a read-only memory (ROM). The ROM generally stores booting programs that run when a computer is turned on and the RAM is used for fast performance, e.g., loading a program and/or calculating data.

The processor 230 executes instructions which implement tasks or functions of programs. When a user executes a program, the processor 230 reads the program stored in the storage 210, loads the program on the RAM, and executes instructions prescribed by the program. In this way, a user may execute programs stored in the remote devices 170, the servers 140-160 and the bedside device 130.

A user may input, modify, and/or update personal data via the input device 260 that may include a keyboard, a mouse, or any other device with which the user may input data. The display device 250 displays data on a display screen. The display device 250 may have a touch screen so that the display device 250 can be used as an input device.

The expansion 240 may include several ports, such as one or more universal serial buses (USBs), IEEE 1394 ports, parallel ports, and/or expansion slots such as peripheral component interconnect (PCI) and PCI express (PCIe) that expands functionalities of the hardware configuration 200. The expansion 240 is not limited to the list but may include other slots or ports that can be used for appropriate purposes of the remote devices 170 in the system 10. The expansion 240 may be used to install hardware or add additional functionalities to a computer that may facilitate the purposes of the remote devices 170. For example, a USB port can be used for adding additional storage to the computer and/or an IEEE 1394 may be used for receiving moving/still image data from an X-ray device or magnetic resonance imaging device, where the display device 250 may display the moving/still image data on the display screen.

The network card 270 is used to communicate with the servers 140-160, the printer 180, the bedside device 130, the sensor 120, and/or the ventilation device 110, wirelessly or via a wired connection through network 280. The remote devices 170 may receive, input, modify, and/or update personal data from and to the servers 140-160 by using the network card 270. A user of the hardware configuration 200 may send a record to the printer 180 via the network card 270 to print information.

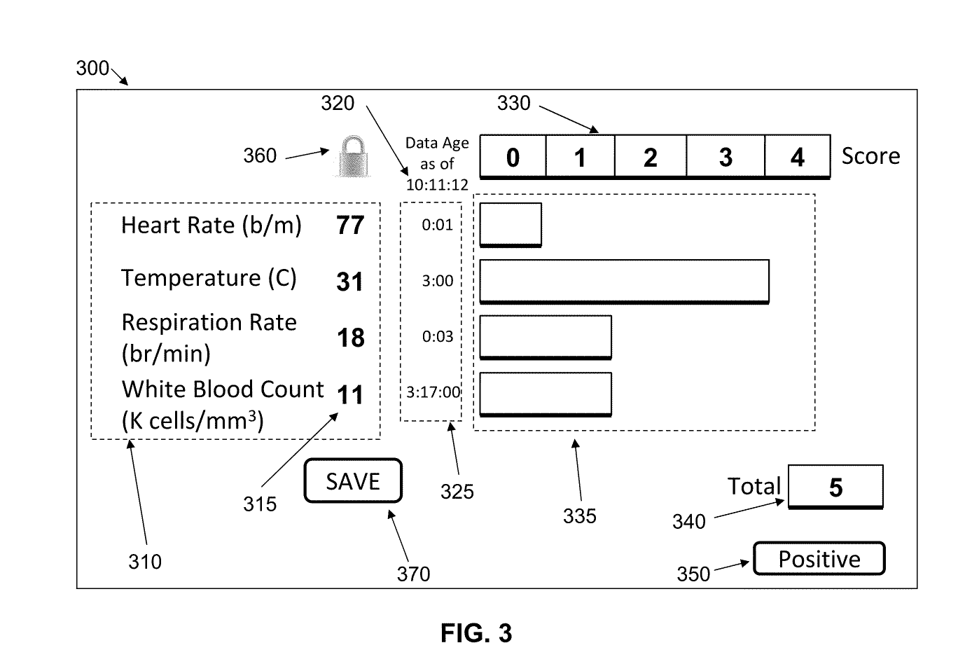

FIG. 3 illustrates personal data displayed on a display screen 300 provided for screening for early identification of a disease. This display screen may appear on a monitor 120, a bedside device 130, or a remote device 170. As described above, the display screen 300 may be a screen of the remote devices 170 of FIG. 2. The display screen 300 displays information including medical data type 310 and values 315, current time 320 and data age 325 of each medical data, score reference bar 330 and score bars 335 of the medical data, total score 340, and suggested diagnosis result 350. Displayed medical data is provided as an example for early diagnosis of systemic inflammatory response syndrome (SIRS).

SIRS is an inflammatory state affecting whole body and is often recognized by the response of the immune system to infection. A patient may develop SIRS as a result of suffering initially from a wide variety of other conditions including acute lung injury, shock, renal failure, respiratory distress syndrome, central nerve system dysfunction, and multiple organ dysfunction syndrome. Thus, earlier diagnosis of SIRS may substantially benefit patients already suffering from severe or life threatening conditions.

Criteria for SIRS have been established in a medical journal, “Definitions for Sepsis and Organ Failure and Guidelines for the Use of Innovative Therapies in Sepsis” presented in “American College of Chest Physicians/Society of Critical Care Medicine Consensus Conference” which was published on Jun. 6, 1992. These criteria include four medical data types and corresponding medical data value ranges, as follows in TABLE 1.

TABLE 1

| Medical data type | Medical data value range |
|---|---|
| Body Temperature | <36° C. (96.8° F.) or >38° C. (100.4° F.) |
| Heart rate | >90/minute |
| Respiratory Rate | >20/minute |
| White Blood Cell Counts | <4,000/mm³ or >12,000/mm³ |

In a case when two or more of these criteria are present, or in other words, two or more medical data values are within the corresponding medical data value ranges, a patient can be diagnosed to have SIRS. These criteria may also be used for earlier diagnosis of sepsis. Sepsis may be diagnosed when two or more medical data are within the corresponding medical data value ranges and a patient has a proven or suspected infection.

The display screen 300 displays the criteria for screening for early identification of SIRS, as an example. However, the display screen 300 may display different medical data for other diseases. According to this example, the display screen 300 displays the medical data types 310 of the criteria of SIRS, namely, heart rate, body temperature, respiratory rate, and white blood cell count. The heart rate is measured in beats per minute (b/min), the body temperature is measured in degrees Celsius (° C.), the respirator rate is in the number of breathing per minute (br/min), and the white blood cell count is in thousand cells in a cubic millimeter (K cells/mm³).

The medical data values 315 are displayed right next to the corresponding medical data types 310. Specifically, the medical data values 315 are 77 beats per minute for the heart rate, 31° C. for the body temperature, 18 breaths per minute for the respiratory rate, and 11,000 (i.e., 11 K) white blood cells in a cubic millimeter for the white blood cell count. As displayed, each medical data value is positioned next to each corresponding medical data type in the right side or in close proximity.

The current time 320 shows the current local time at the location of the device, e.g., 10:11:12. The current time 320 may be displayed in 12-hour clock format with am for the morning and pm for the afternoon. Since the wall clock time 320 does not have am and pm, the wall clock time 320 is displayed in 24-hour clock format in the display screen 300, meaning that current displaying time is 10:11:12 am in 12-hour clock format.

The data ages 325 are displayed in close proximity to the corresponding medical data values 315 in a manner that any user may recognize that a data age represents the age of a medical data value. As shown in FIG. 3, the heart rate data value 77 is one second old, meaning that the heart rate value was refreshed one second ago, and the white blood cell count 11 K is three hours and seventeen minutes old.

In embodiments, the data ages 325 may be displayed in different ways. For example, when a data age for the white blood cell count was measured 5 days 5 hours 5 minutes 10 seconds before displaying the white blood cell count, the display screen 300 may display the date age of the white blood cell count as 5D 5H 5M 10S or 5D 5:05:10.

When a medical professional make a measurement of the white blood cell count, the measured result is typically recorded in lab print outs on paper or in an electronic file. The measured result is generally recorded with the measurement time when the result was measured. The data age for the measured result is calculated by subtracting the measurement time from the current time. For example, if a white blood cell count is measured as 11,000 at 2:30:05 pm on July 6 and is displayed on a display screen at 4:31:15 pm on July 8, then the data age for the white blood cell count would be 2 days 2 hours 1 minute and 10 seconds. The display screen might then display the data age following the time format that the device uses, i.e., 2D 2H 1M 10S, 2D 2:01:10, or 50:01:10.

In embodiments, software that calculates the data ages 325 is able to compensate the time difference between a time zone of display and a time zone of measurement, when medical data are measured in a different time zone from the time zone of display. For example, when the white blood cell count is measured at a lab in California at 2:30:05 pm on July 6 and a medical professional looks at the measured value in New York at 4:31:15 pm on July 8 by utilizing the display screen 300, the lab or equipment that measures the white blood cell count has a device identification information that includes the location where the lab or the equipment is located. Thus, by looking at the device identification information, the time zone where the medical data was measured can be identified and can be considered in calculating the time difference. Thus, the data age pertaining to the white blood cell count would be calculated as 2 days 5 hours (instead of 2 hours) 1 minute and 10 seconds. In this way, data ages for medical data are calculated and a medical professional may acknowledge how old each medical data value is by looking at the data age of each medical data value.

In one embodiment, the time 320 may represent the time that the most recent update, modification, or entry of any of the medical data occurred. As some of the data types are refreshed quite regularly (e.g., heart rate and respiration rate), this does not represent a significant delay clinically, but eliminates the need for four separate clocks to be running simultaneously for each of the data types based. Rather the data age 325 may be calculated by subtracting the most recent measurement time of each medical data type from the most recent time 320 that any of the data have been updated. This greatly simplifies the processing of the data age 325 by reducing it to four subtraction steps, that occur each time any of the medical data types are updated.

As illustrated in FIG. 3, the heart rate data value, 77 b/min, is 1 second old, the body temperature, 31° C., is 3 minutes old, the respiratory rate, 18 br/min, is 3 second old, and the white blood cell count, 11 K cells/mm³, is 3 hours 17 minutes old. Different medical data type has a different shelf-life. For example, heart rate is a very quickly changing parameter and can change with simple activities including watching TV, standing from a seated position, or other activities a patient might routinely undertake. Thus the shelf life of heart rate is essentially very short.

On the other hand, a white blood cell count may have hours of shelf-life because it can be only measured in a laboratory following the taking of a blood sample. Indeed, in view of the cost, unless necessary this testing is not usually performed more than once a day, and often even less frequently. Thus, a medical professional may have no confidence in an indicated heart rate that is minutes old but yet have some level of confidence in a white blood cell count that is hours old.

In embodiments, data ages may be provided with extra guidance and visual cueing to medical professionals when displaying the data ages. Variants, such as shading, color coding, boxing, hiding, highlighting, or otherwise decorating data ages may be considered. A value with such variants is both to show a data value is no longer satisfactory or valid due to the corresponding data age and to simultaneously provide medical professionals with an indication of the last such reading for the given patient.

The score reference bar 330 shows scores that indicates how serious each medical data value is based on criteria. Score zero indicates no relevance to SIRS or indicates that measured result is in a normal range. Score one shows that the measured result is very close to but below the threshold of criterion and may indicate a precautionary situation. For example, the measured respiratory rate is 18 br/min which is close to but below the lower threshold of 20 br/min as shown in TABLE 1. Score two may indicate that the tested value is within the range of values. For example, when a measured respiratory rate is 21 or 22 br/min, its score would be two. Score three indicates serious, meaning that the measured value is well within the criterion. For example, tested respiratory rate is 26 or 28 br/min. Score four means that the measured value is within the criterion and yet far from the threshold and may indicate special attention to the medical situation. For example, tested respiratory rate is 40 br/min. In this way, layered yet simple set of rules may be incorporated into scoring medical data values. The simple set of rules may be different per hospital, per ward, per doctor, or per patient basis depending on condition of the patient or general medical practice of the regions where the hospital, ward, or doctor is located.

The scores 335 shows scores for the medical data values 325. For the heart rate, the criterion of the heart rate is that the heart rate is greater than 90 beats per minute. Since the measured value for the heart rate is 70 which is well below the threshold 90, the seriousness of the heart rate is scored zero with regard to screening for early identification of SIRS. The respiratory rate 18 br/min and the white blood cell count 11 k cells/min are close to but below the criteria of the respiratory rate based on TABLE 1 above. Thus, the precaution should be taken to watch over the respiratory rate and the white blood cell count and their scores are one.

On the other hands, the body temperature scored three, meaning it indicates a serious aspect of the condition. The criterion for the body temperature is less than 36° C. or greater than 38° C. The measured body temperature is 31° C. which is substantially less than 36° C. Based on the matrix of scoring, 31° C. may be scored four. According to the scoring standard described in the score reference bar 330, however, the body temperature scores three and special attention should be made to control the body temperature.

In embodiments, variants, such as shading, color coding, boxing, hiding, highlighting, or otherwise decorating data ages may be also utilized in decorating scores 335 of measured values 325. For example, a score bar representing the score of the body temperature, i.e., score three, may use an outstanding color or highlighting so that the seriousness of the body temperature can be easily recognized by any one including medical professionals, and a score bar representing a score of the heart rate, i.e., score zero, may use a moderate color so that medical professionals feels that the heart rate is not as important as the body temperature. However, such variants are not limited to the list provided in this disclosure but may encompass other ways that people in the ordinary skill in the art can generally think of.

The total score 340 sums up the scores of the data values 315. For the example shown in FIG. 3, the total score is five. The total score 340 may be used in screening for early identification of a disease.

The screening result 350 indicates likelihood of a disease, e.g., SIRS. As described above, one criterion for diagnosing SIRS is that two or more data values of the four medical data types 310 are in the corresponding ranges which are shown in TABLE 1. Using that screening algorithm, one would expect the screening result 350 in FIG. 3 to be negative because only one criterion, the body temperature, is within the range specified by the table. However, by using a different screening algorithm as described above, where a composite or total score 340 of all the criteria is considered, and where a score is given to parameters that are near but not within the ranges specified in Table 1, a different screening result, one that may be determined to pass the screening for an earlier stage of the disease or infection, may be reached.

Using the scoring system shown in FIG. 3, if two of the criteria for diagnosing SIRS were within the ranges specified in Table 1, the minimum score for diagnosing SIRS is a 4. That is two of the criteria are within the ranges of Table 1 and the other two are well below the lower threshold. Using this as a baseline for the total score algorithm, a positive screening result 350 may be achieved if a total score of 4 or greater is reached, even if none of the criteria or as shown in FIG. 3 only one of the criteria are within the ranges of Table 1.

The display screen 300 further includes an authentication symbol 360 and a save button 370. The authentication symbol 360 enables a medical professional to modify the data values 315 or to enter a new data value. The authentication symbol 360 may be a toggle switch, meaning that clicking the authentication symbol 360 once enables the modification or entering new data values and clicking it twice disables the features of modification. A representative image of the authentication symbol 360 may have two images, one for enabling modification and the other one for disabling modification. A closed lock image may be used for disablement and an open lock image may be used for enablement.

The authentication symbol 360 may be used to protect the medical data values in a manner that only an authorized medical personnel can enter, modify, or update the medical data values and associated measurement times. Means for authentication may include identification and corresponding password, bio-print protection, and/or facial recognition. Means for authentication may also include other generally accepted methods by a person in the ordinary skill in the authentication area. During the modification or update of the medical data values, software for these features may have a validation process that checks whether a user who enters, modifies, or updates the medical data values also enters corresponding measurement time. If the user forgets to enter the corresponding measurement time and advances to finish the modification, the software prevents the user from saving or finishing the modification or update and notifies the user that the measurement time should be entered.

The save button 370 is for saving modified or updated medical data values. Since the modification and update are protected, the save button 370 is shown as disabled by dimming the save button 370. In this way, no one can press the save button unless the authentication symbol 360 is clicked/activated and authentication information of a user is properly authenticated. After the authentication is successful, the save button may be activated so that the authenticated user may save the modified or updated medical data values together with corresponding measurement times to the system.

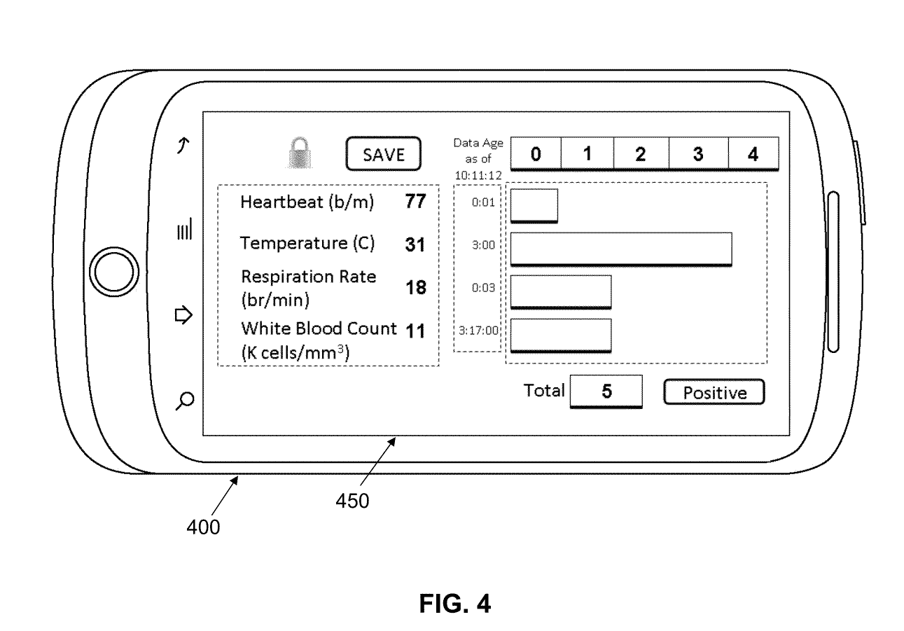

FIG. 4 illustrates a mobile device 400 that displays personal medical data on a display screen 450. The mobile device 400 may be one of the remote devices 170 of FIG. 1 and be a handheld personal device including a smartphone. The mobile device includes the display screen 450 that may display the display screen 300 of FIG. 3 without modifying the layout of the display screen 300. However, the mobile device 400 may have to re-configure the layout of the display screen 300 due to the size limitation so that all relevant information displayed on the display screen 300 may be displayed on the display screen 450. Reconfiguration of the layout displayed in FIG. 4 is an example, and may use numerical values instead of using the score bars to reduce the space without losing any relevant information and display the information fitting to the size of the display screen 450. The mobile device 400 may have all the functionalities including authentication and saving features so that medical data values can be entered, modified, or updated anywhere within the network 280.

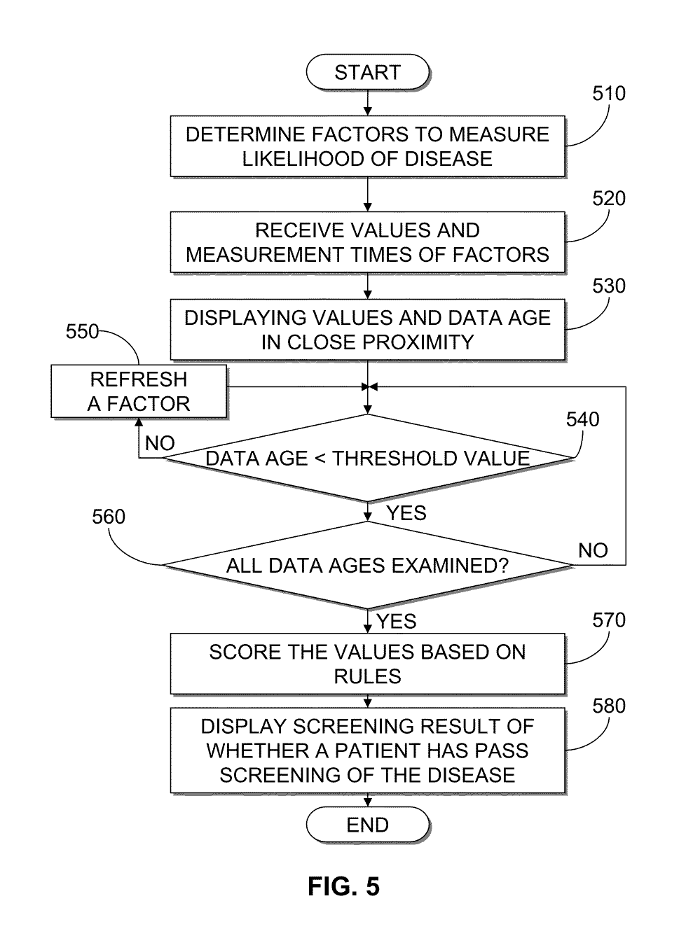

FIG. 5 is a flow diagram illustrating a method of managing personal data. The method manages and displays personal medical data to screen for early identification of a disease. In particular, the method displays the personal medical data with associated data ages of the personal medical data so that a medical professional may determine validity of the personal medical data.

The method starts from determining relevant factors to measure likelihood of a disease in step 510. For example, relevant factors are heart rate, body temperature, respiratory rate, and white blood cell count to diagnose SIRS. In step 520, measured medical data values for the relevant factors are received with associated measurement times when the medical data values were measured. Receiving the medical data may be accomplished via wired or wireless network. Some medical data values, such as body temperature, respiratory rate, or heart rate, may be automatically and/or continuously measured by the sensors 120 or the bedside device 130 and transferred to the servers 140-160 that relay the information to the remote devices 170 as illustrated in FIG. 1. In embodiments, the medical data values may be requested and be transferred to the servers together with the measurement times.

In step 530, the medical data values and the corresponding data ages are displayed on a display screen in a close proximity so that any medical professional may recognize how old each medical data value is.

In step 540, each data age is compared to a corresponding threshold value. The data age is calculated by subtracting measurement time from displaying time. Since different medical data values have different shelf-lives, each threshold value of the medical data may be different from each other. When it is determined that the data age of a medical data value is greater than or equal to a corresponding threshold time limit, meaning that the medical data value is no longer valid, the medical data is to be refreshed in step 550. Since the measurement time of the medical data is present after the refreshing, the data age of the measured medical data value is close to zero. Thus, in step 540 after step 550 is processed, the data age is less than the threshold value and the method proceeds to step 560.

In step 550, after refreshing of the medical data, an authentication symbol may be displayed on a display screen such that a medical professional needs to enter identification and corresponding password, or other authentication information to modify or update the medical data value and also to prevent un-authorized person from modifying the medical data values.

In step 560, it is determined whether all data ages are compared to the corresponding threshold values. If there is more data age to be compared, the method goes back to step 540, and, if not, step 570 follows. In step 570, scores of the medical data values are determined based on a set of rules. As shown in TABLE 1, each of medical data has a range of values that can indicate likelihood of SIRS. The range of values is one of major factors to be considered in determining the rules. Other factors may include the medical conditions or history of a patient. When factors are incorporated into a set of rules, the method can determine a score for each medical data value in step 570. As described above, the score may be represented as a numerical value or a bar graph. The score may be decorated with shading, color coding, boxing, hiding, or highlighting so that any medical professionals may easily recognize which medical data value has to be considered seriously compared to other medical data values.

In step 580, the screening result is determined and displayed the screening result for early identification of SIRS may be based on the number of medical data which fall on the range shown in TABLE 1 or the total score algorithm as described above, or other variations known to those of skill in the art for diagnosing a particular disease or condition. Based on the displayed screening result, a medical professional may provide timely and appropriate medical treatments for the patient.

While several embodiments of the disclosure have been shown in the drawings and described in detail hereinabove, it is not intended that the disclosure be limited thereto, as it is intended that the disclosure be as broad in scope as the art will allow. Therefore, the above description and appended drawings should not be construed as limiting, but merely as exemplifications of particular embodiments. Those skilled in the art will envision other modifications within the scope and spirit of the claims appended hereto.

What is claimed is:

1. A system for displaying patient data, comprising:
a computing device including a processor and a data input for receiving measured values and measurement times of a plurality of factors related to screening of a particular disease; and
a display configured to display a user interface, including:
the plurality of factors;
the measured values for each of the plurality of factors;
data ages of the measured values; and
a score, calculated by the processor, of the measured value as a function of the particular disease based on the measured values and the data ages for the plurality of factors; and
a screening result.

2. The system according to claim 1,
wherein the particular disease is the systemic inflammatory response syndrome, and
wherein the plurality of factors are a heart rate, a body temperature, a respiratory rate, and a white blood cell count.

3. The system according to claim 1, wherein the data age is calculated by subtracting a measurement time of a factor from the current time.

4. The system according to claim 1, wherein a sum of the scores is considered to determine the screening result.

5. The system according to claim 4, wherein the screening result is positive or negative.

6. The system according to claim 4, wherein the display further displays scores of the plurality of factors and the sum of the scores.

7. The system according to claim 1, wherein the plurality of factors considered for diagnosing a disease are selectable by a user based on the disease for which diagnosis is sought.

8. The system according to claim 1, wherein a value of a factor is refreshed when the corresponding data age of the factor is greater than or equal to a predetermined time.

9. The system according to claim 1, further comprising:
an authentication unit configured to authenticate a user so that the user edits a value and a time of measurement of a factor,
wherein the display displays an authentication symbol.

10. The system according to claim 9,
wherein the authentication symbol is a toggle switch,
wherein the values and the data ages of the plurality of factors can be edited and saved when the authentication symbol is switched to unlock, and
wherein the values and the data ages of the plurality of factors cannot be edited and saved when the authentication symbol is switched to lock.

11. A method for displaying patient data, the method comprising:
receiving measured values and measurement times of a plurality of factors;
displaying the plurality of factors and the corresponding values and data ages in close proximity;
scoring the measured value of a factor as a function of a disease based on the values and the data ages of the plurality of factors; and
determining a screening result of the disease.

12. The method according to claim 11,
wherein the disease is SIRS, and
wherein the factors are a heart rate, a body temperature, a respiratory rate, and a white blood cell count.

13. The method according to claim 11, wherein the data age is calculated by subtracting a measurement time from the current time.

14. The method according to claim 11, further comprising:
displaying the screening result of whether the patient has pass the screening of the disease,
wherein the displayed screening result is positive or negative.

15. The method according to claim 11, further comprising:
displaying scores of the factors and a total score of the scores.

16. The method according to claim 15, wherein the screening result of whether the patient has passed the screening of the disease based on the total score.

17. The method according to claim 11, further comprising:
refreshing a value of a factor when the corresponding data age of the factor is greater than or equal to a predetermined time.

18. The method according to claim 11, further comprising:
displaying an authentication symbol; and
authenticating a user so that the user edits a value and a measurement time of a factor.

19. The method according to claim 18,
wherein the authentication symbol is a toggle switch,
wherein the values and the data age of the plurality of factors can be edited and saved when the authentication symbol is switched to unlock, and
wherein the values and the data age of the plurality of factors can not be edited and saved when the authentication symbol is switched to lock.

20. A computer-readable storage medium storing a program that, when executed by a processor, implements a method for displaying patient data, the method comprising:
receiving measured values and measurement times of a plurality of factors;
displaying the factors and the corresponding values and data age in close proximity;
scoring the measured value of a factor as a function of the disease based on the values and the data ages of the plurality of factors; and
determining a screening result of the disease.
